(19) United States
(12) Patent Application Publication
(10) Pub. No.: US 2026/0237816 A1
(43) Pub. Date: Aug. 13, 2026

(54) Battery Cell Assembly, Battery System Including Same, and Manufacturing Method of Same

(71) Applicant: SK On Co., Ltd., Seoul (KR)

(72) Inventors: Hui Jun SHIN, Daejeon (KR); Bon Seok KU, Daejeon (KR); Chong Pyo HONG, Daejeon (KR)

(21) Appl. No.: 19/531,953

(22) Filed: Feb. 6, 2026

(30) Foreign Application Priority Data
Feb. 11, 2025 (KR) 10-2025-0017166

(51) Int. Cl. H01M 50/242; H01M 50/105; H01M 50/211; H01M 50/262; H01M 50/271; H01M 50/291; H01M 50/503; H01M 50/507; H01M 50/548

(52) U.S. Cl. CPC H01M 50/242; H01M 50/105; H01M 50/211; H01M 50/262; H01M 50/271; H01M 50/291; H01M 50/503; H01M 50/507; H01M 50/548

(57) ABSTRACT

A battery cell assembly includes: a battery cell including an exterior material housing an electrode assembly therein, and a first terminal and a second terminal electrically connected to the electrode assembly and protruding outward from the exterior material; a cell case including a support surface facing one side of the battery cell, an opening surface facing the support surface, and first and second surfaces extending perpendicular to the support surface from opposite ends of the support surface toward the opening surface; a first bus bar electrically connected to the first terminal; a second bus bar electrically connected to the second terminal; and a bus bar frame including a first frame and a second frame each supporting the first bus bar and the second bus bar, and a connecting frame of which at least a portion protrudes from the opening surface and which includes the first frame and the second frame.

### CROSS-REFERENCE TO RELATED PATENT APPLICATION

The present application claims priority under 35 U.S.C. § 119(a) to Korean patent application number 10-2025-0017166 filed on Feb. 11, 2025, in the Ministry of Intellectual Property, the entire disclosure of which is incorporated by reference herein.

### BACKGROUND OF THE INVENTION

### 1. Field

The present disclosure relates to a battery cell assembly, a battery system including the same, and a manufacturing method of the same. Specifically, the present disclosure relates to a battery cell assembly with improved structural stability.

### 2. Description of the Related Art

A typical cell-to-pack (hereinafter, CTP) battery assembly includes a plurality of battery cells and a housing that forms a receiving space that houses the plurality of battery cells. Because the battery cells must be placed directly within the housing, the rigidity of the battery cells themselves must exceed a predetermined standard. Pouch-type batteries are formed without the upper and lower cases, making them susceptible to deformation. Therefore, there is a need to reinforce the rigidity and structural stability of pouch-type batteries.

### SUMMARY OF THE INVENTION

First, according to an aspect of the present disclosure, the challenge is to improve the structural stability of a battery cell assembly.

Second, according to another aspect of the present disclosure, the challenge is to efficiently utilize the space of a battery assembly.

Third, according to another aspect of the present disclosure, the challenge is to improve the reliability of a battery system.

Meanwhile, the present disclosure may be widely applied to green technology fields such as electric vehicles, battery charging stations, energy storage systems (ESS), and other battery-based photovoltaics and wind power. Furthermore, the present disclosure may be used in eco-friendly mobility, including electric vehicles and hybrid vehicles, to prevent climate change by reducing air pollution and greenhouse gas emissions.

A battery cell assembly according to the present disclosure may include: a battery cell including an exterior material housing an electrode assembly therein, and a first terminal and a second terminal electrically connected to the electrode assembly and protruding outward from the exterior material; a cell case including a support surface facing one side of the battery cell, an opening surface facing the support surface, and first and second surfaces extending perpendicular to the support surface from opposite ends of the support surface toward the opening surface; a first bus bar electrically connected to the first terminal; a second bus bar electrically connected to the second terminal; and a bus bar frame including a first frame and a second frame each supporting the first bus bar and the second bus bar, and a connecting frame of which at least a portion protrudes from the opening surface and which includes the first frame and the second frame.

In an embodiment, the first frame, the second frame, and the connecting frame may be formed integrally.

In an embodiment, the busbar frame may have a U-shape.

In an embodiment, the first frame may include a first groove that is at least partially sunken in a direction toward the battery cell, and the second frame may include a second groove that is at least partially sunken in a direction toward the battery cell.

In an embodiment, the first bus bar may be arranged facing the first groove, and the second bus bar may be arranged facing the second groove.

In an embodiment, the thickness of the sunken portion of the first groove may be greater than or equal to the thickness of the corresponding first bus bar, and the thickness of the sunken portion of the second groove may be greater than or equal to the thickness of the corresponding second bus bar.

In an embodiment, each of the first busbar and the second busbar may include at least one bent portion.

In an embodiment, each of the first bus bar and the second bus bar may have an L-shape.

In an embodiment, the battery cell assembly may further include a fixing member arranged on the connecting frame and fixing the connecting frame and the first surface and the second surface of the cell case.

In an embodiment, the battery cell assembly may further include: a first insulating cover arranged on the outside of the first busbar; and a second insulating cover arranged on the outside of the second busbar.

In an embodiment, the busbar frame may be spaced apart from the support surface of the cell case.

In an embodiment, the first bus bar is coupled to the first terminal by a joint, and the second bus bar is coupled to the second terminal by a joint.

A battery system according to the present disclosure may include: a plurality of battery cell assembly; a connecting busbar electrically that connects the plurality of battery cell assemblies; and a housing that houses the plurality of battery cell assemblies and the connecting busbar, wherein the battery cell assembly includes: a battery cell including an exterior material housing an electrode assembly therein, and a first terminal and a second terminal electrically connected to the electrode assembly and protruding outward from the exterior material; a cell case including a support surface facing one side of the battery cell, an opening surface facing the support surface, and first and second surfaces extending perpendicular to the support surface from opposite ends of the support surface toward the opening surface; a first bus bar electrically connected to the first terminal; a second bus bar electrically connected to the second terminal; and a bus bar frame including a first frame and a second frame each supporting the first bus bar and the second bus bar, and a connecting frame of which at least a portion protrudes from the opening surface and which includes the first frame and the second frame.

In an embodiment, the battery system may further include at least one cell pad arranged between the plurality of battery cell assemblies.

In an embodiment, the housing may include: a pack body having an opening on one surface and forming a receiving space that houses the plurality of battery cell assemblies and the connecting busbar through the opening; and a pack cover coupled to the pack body to form the receiving space together and covering the opening.

In an embodiment, the first bus bar and the second bus bar may each include an opening hole penetrating in a direction from the pack cover toward the pack body.

In an embodiment, the connecting bus bar may be electrically connected to at least one of the first bus bar or the second bus bar through the opening hole.

In an embodiment, the connecting frame may support the pack cover.

A method of manufacturing a battery cell assembly including an exterior material that houses an electrode assembly therein and a battery cell including a first terminal and a second terminal electrically connected to the electrode assembly and protruding outward from the exterior material, and a cell case that houses the battery cell may include: inserting the battery cell into the cell case, the cell case including a support surface, an opening facing the support surface, and first and second surfaces extending perpendicular to the support surface and toward the opening from opposite ends of the support surface; and coupling a busbar frame to the cell case, the busbar frame including a first busbar electrically connected to the first terminal, a second busbar electrically connected to the second terminal, a first frame and a second frame that respectively support the first and second busbars, and a connecting frame of which at least a portion protrudes from the opening surface to connect the first and second frames.

In an embodiment, the method may further include attaching a fixing member that connects the first surface and the second surface of the cell case to the connecting frame.

First, according to an aspect of the present disclosure, the challenge is to improve the structural stability of a battery cell assembly.

Second, according to another aspect of the present disclosure, the challenge is to efficiently utilize the space of a battery assembly.

Third, according to another aspect of the present disclosure, the challenge is to improve the reliability of a battery system.

### BRIEF DESCRIPTION OF THE DRAWINGS

FIG. 1 is a perspective view illustrating a battery cell assembly according to an embodiment of the present disclosure.

FIG. 2 is an exploded perspective view illustrating a battery cell assembly of FIG. 1.

FIG. 3 is an exploded perspective view of a battery cell according to an embodiment of the present disclosure.

FIG. 4 is a front view of a busbar frame, a first busbar, and a second busbar of FIG. 1.

FIG. 5 is a front view of a battery cell assembly according to an embodiment of the present disclosure.

FIG. 6 is a front view of a battery cell assembly according to another embodiment of the present disclosure.

FIG. 7 is a perspective view of a battery system according to an embodiment of the present disclosure.

FIG. 8 is a cross-sectional view of a battery system as viewed from the stacking direction of a battery cell assembly.

FIG. 9 is a plan view of a portion of a battery system of FIG. 7.

FIG. 10 is a flowchart illustrating a method of manufacturing a battery cell assembly according to an embodiment of the present disclosure.

### DETAILED DESCRIPTION

Hereinafter, preferred embodiments of the present disclosure will be described in detail with reference to the accompanying drawings. The configuration of the apparatus or control method described hereinafter is for the purpose of illustrating embodiments of the present disclosure and is not intended to limit the scope of the present disclosure, and the same reference numerals used throughout the specification refer to the same components.

The use of terms such as “first,” “second,” “third,” and the like to precede components referred to herein is intended to avoid confusion as to the components to which they refer, and is not intended to indicate any order, importance, or master-servant relationship among the components. For example, it is possible to practice an invention including only the second component without the first component.

As used herein, the singular expression includes the plural unless the context clearly indicates otherwise.

As used herein, a battery cell may be synonymous with a secondary battery, cell, or battery. For example, a battery cell refers to a lithium rechargeable battery, more specifically a basic unit of a lithium-ion battery, that can charge and discharge electrical energy. The main components of a battery cell are a cathode, an anode, a separator, and an electrolyte, and the main components are enclosed in a case (or pouch). Said battery cell may further include tabs, which are connected to said anode and said cathode for electrical connection with the outside, respectively, and which protrude outwardly from said pouch.

Meanwhile, a battery cell assembly as described herein refers to an assembly in which said battery cells are bundled in one or more counts and placed in a cell case to protect them from external shock, heat, vibration, and the like.

In the present disclosure, a battery system may be any one of a battery module, a battery pack, or an energy storage system including a plurality of battery cell assemblies. Alternatively, the battery system may be a battery pack with a cell to pack (CTP) structure that houses battery cells without a battery module. The battery system may be connected to a bus bar housed inside through an external connection line to supply electricity to the outside or receive electricity from the outside and store it in the battery cell.

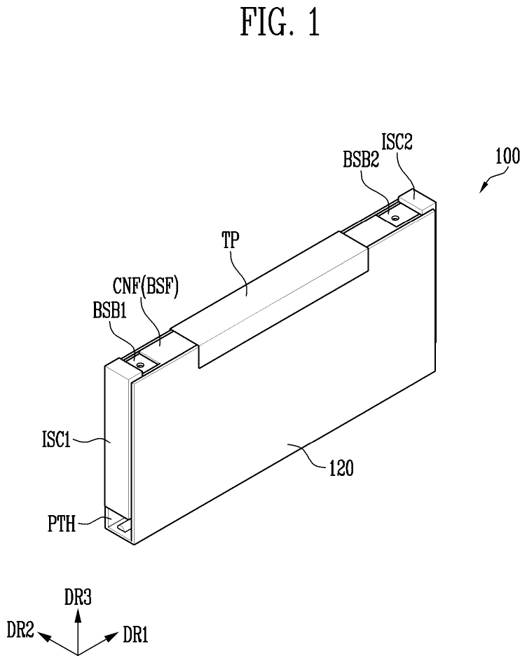

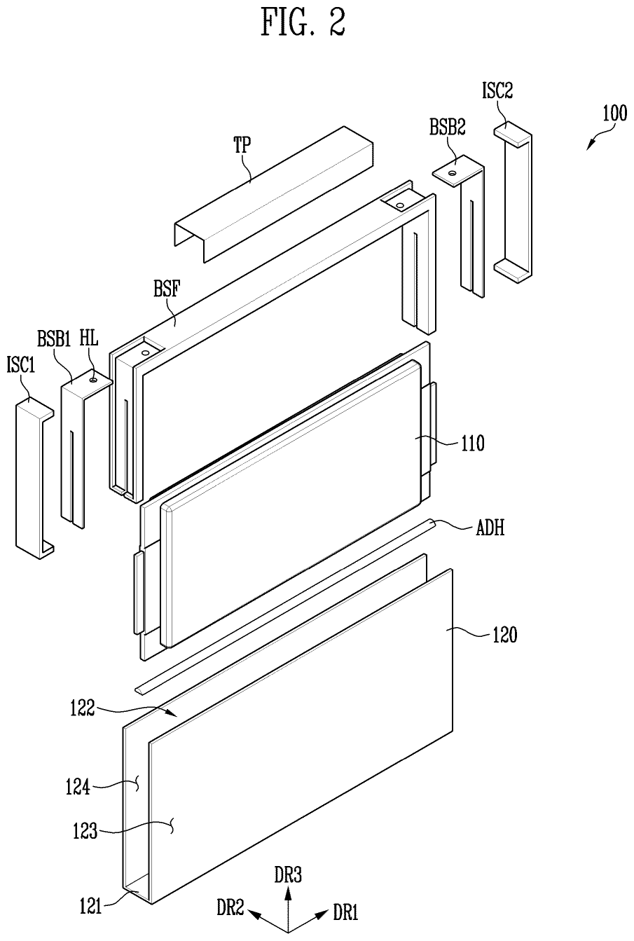

FIG. 1 is a perspective view illustrating a battery cell assembly according to an embodiment of the present disclosure. FIG. 2 is an exploded perspective view illustrating a battery cell assembly of FIG. 1.

Referring to FIGS. 1 and 2, the battery cell assembly 100 may include a battery cell 110 including an exterior material 114 that houses an electrode assembly 112 therein, a first terminal 112a and a second terminal 112b that are electrically connected to the electrode assembly 112 and protrude outward from the exterior material 114, and a cell case 120 including a support surface 121 facing one side of the battery cell 110, an opening surface 122 facing the support surface 121, and including a first surface 123 and a second surface 124 that extend perpendicular to the support surface 121 and toward the opening surface 122 from opposite ends of the support surface 121, a first bus bar BSB1 that is electrically connected to the first terminal 112a, a second bus bar BSB2 that is electrically connected to the second terminal 112b, and a busbar frame BSF including a first frame FRM1 and a second frame FRM2 that support a first busbar BSB1 and a second busbar BSB2, respectively, and a connecting frame CNF of which at least a portion protrudes from the opening 122 and connects the first frame FRM1 and the second frame FRM2.

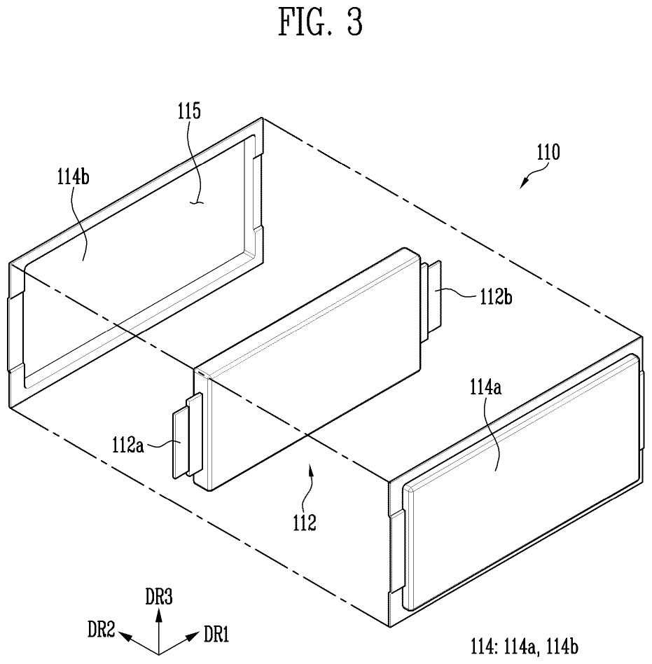

FIG. 3 is an exploded perspective view of a battery cell according to an embodiment of the present disclosure.

Referring to FIG. 3, each battery cell 110 may include an electrode assembly 112.

The electrode assembly 112 may include a cathode and an anode. The cathode may include a cathode current collector and a cathode active material coated on at least one surface of the cathode current collector. The cathode current collector may include any known conductive material that does not cause a chemical reaction within a lithium secondary battery. The cathode current collector may include, for example, stainless steel, nickel (Ni), aluminum (Al), titanium (Ti), copper (Cu), or any alloy thereof, and may be provided in various forms, such as a film, sheet, or foil. The cathode active material may include a material capable of intercalating and deintercalating lithium ions. The cathode active material may be, for example, a lithium metal oxide.

The anode may include an anode current collector and an anode active material coated on at least one surface of the anode current collector. The anode current collector may include any known conductive material that does not cause a chemical reaction within a lithium secondary battery. The anode current collector may include, for example, any one of stainless steel, nickel (Ni), aluminum (Al), titanium (Ti), copper (Cu), and alloys thereof, and may be provided in various forms, such as a film, sheet, or foil. The anode active material may include a material capable of intercalating and deintercalating lithium ions. The anode active material may include, for example, a carbon-based material such as crystalline carbon, amorphous carbon, a carbon composite, or carbon fiber; a lithium alloy; silicon (Si); and tin (Sn), or a combination thereof.

In an embodiment, the cathode and anode may further include a binder and a conductive material, respectively, to enhance mechanical stability and electrical conductivity.

In an embodiment, each battery cell 110 may further include a separator to prevent electrical short-circuiting between the cathode and anode and to facilitate ion flow. The separator may include, for example, a porous polymer film or a porous non-woven fabric.

The electrode assembly 112 may have a structure in which the cathode, separator, and anode are stacked along a predetermined stacking direction. The cathode, separator, and anode may be stacked in a stacking, stack-folding, or Z-stacking manner.

In an embodiment, each battery cell 110 may include an electrolyte to immerse the electrode assembly 112 contained in the exterior material 114. The electrolyte may be a non-aqueous electrolyte. The electrolyte may include a lithium salt and an organic solvent, and may further include additives as needed.

In another embodiment, each battery cell 110 may further include a solid electrolyte layer including a solid electrolyte. In this case, the electrode assembly 112 may have a structure in which a cathode, a solid electrolyte layer, and an anode are laminated along a predetermined stacking direction.

Each battery cell 110 may include an exterior material 114. The exterior material 114 may house the electrode assembly 112 within the battery. Specifically, the electrode assembly 112 may be housed within the battery by forming a receiving space within the battery. The exterior material 114 may enclose and protect the electrode assembly 112 by housing the electrode assembly 112 within the battery.

Each of the battery cells 110 may be classified into pouch-type batteries, prismatic batteries, cylindrical batteries, etc., depending on the shape of the exterior material 114. For convenience of explanation, the present disclosure illustrates a pouch-type secondary battery as an example, but is not necessarily limited thereto.

In an embodiment, the exterior material 114 may include a first cover 114a and a second cover 114b. The first cover 114a and the second cover 114b may be connected to form the receiving space within.

In an embodiment, the first cover 114a and/or the second cover 114b may include a cup portion 115 formed by recessing one surface. In an embodiment, the electrode assembly 112 may be positioned in the cup portion 115.

In an embodiment, the first cover 114a and/or the second cover 114b may be formed integrally as one body and then folded to form the receiving space. In addition, the first cover 114a and/or the second cover 114b may be manufactured separately and sealed.

In an embodiment, the exterior material 114, formed by folding or sealing as described above, may form a receiving space and four outer peripheral surfaces.

In an embodiment, each battery cell 110 may include a first terminal 112a and a second terminal 112b. The first terminal 112a and the second terminal 112b may be electrically connected to the electrode assembly 112 and protrude outward from the exterior material 114. The first terminal 112a and the second terminal 112b may be configured to electrically connect the electrode assembly 112, which is isolated within the exterior material 114, to the outside. To this end, the first terminal 112a and the second terminal 112b may be formed of a conductor with high electrical conductivity, allowing electricity to flow through them.

In an embodiment, the first terminal 112a may be connected to the cathode, and the second terminal 112b may be connected to the anode. In another embodiment, the first terminal 112a may be connected to the anode, and the second terminal 112b may be connected to the cathode.

The first terminal 112a and the second terminal 112b may be formed to protrude outward from different ends of the exterior material 114. The first terminal 112a and the second terminal 112b may protrude in a direction different from the lamination direction. For example, referring to FIG. 1, the first terminal 112a may protrude in a direction opposite to the first direction DR1, and the second terminal 112b may protrude in the first direction DR1. Alternatively, the first terminal 112a may protrude in the first direction DR1, and the second terminal 112b may protrude in a direction opposite to the first direction DR1.

Referring again to FIGS. 1 and 2, the cell case 120 may house the battery cell 110. That is, the cell case 120 may cover and protect the battery cell 110. Therefore, the rigidity of the battery cell assembly 100 may be secured. In an embodiment, the cell case 120 may include aluminum. However, the embodiments are not limited thereto.

The cell case 120 may include a support surface 121 that supports a battery cell 110, an opening surface 122 facing the support surface 121, and a first surface 123 and a second surface 124 that extend from opposite ends of the support surface 121 toward the opening surface 122 so as to face each other with the battery cell interposed therebetween. The support surface 121, the first surface 123, and the second surface 124 may be connected to each other to form a receiving space within the support surface 121. The battery cell 110 may be arranged within the receiving space.

The battery cell 110 may be arranged on the support surface 121. That is, the battery cell 110 may be positioned in a third direction DR3 relative to the support surface 121.

In an embodiment, the battery cell assembly 100 may further include a heat dissipation adhesive ADH. The thermal adhesive ADH may be placed on the support surface 121. The thermal adhesive ADH is placed on the support surface 121 inside the cell case 120, and the battery cell 110 may be attached to the cell case 120 via the thermal adhesive ADH. The thermal adhesive ADH includes a highly thermally conductive material and may dissipate heat emitted from the battery cell 110 to the outside. The thermal adhesive ADH prevents the battery cell 110 from being detached from the support surface 121.

The first surface 123 is adjacent to the first cover 114a of the exterior material 114 of the battery cell 110 and may support the first cover 114a. The second surface 124 is adjacent to the second cover 114b of the exterior material 114 of the battery cell 110 and may support the second cover 114b.

In an embodiment, the first busbar BSB1 and the second busbar BSB2 may be arranged in opposite directions relative to the battery cell 110. The first bus bar BSB1 may be electrically connected to the first terminal 112a. The second bus bar BSB2 may be electrically connected to the second terminal 112b. The first bus bar BSB1 may be coupled to the first terminal 112a by bonding (or a joint), and the second bus bar BSB2 may be coupled to the second terminal 112b by bonding (or a joint). At this time, the bonding may include welding, fusion, hardware fastening, adhesives, etc.

The first bus bar BSB1 may be positioned in the direction in which the first terminal 112a protrudes, and the second bus bar BSB2 may be positioned in the direction in which the second terminal 112b protrudes. That is, the first bus bar BSB1 may be positioned in a direction opposite to the first direction DR1 with respect to the battery cell 110. The second bus bar BSB2 may be positioned in the first direction DR1 relative to the battery cell 110.

In an embodiment, each of the first bus bar BSB1 and the second bus bar BSB2 may include at least one bent portion. For example, each of the first bus bar BSB1 and the second bus bar BSB2 may have an L-shape. The first bus bar BSB1 may be positioned in the direction in which the first terminal 112a protrudes, extends in the third direction DR3, and then bends in the first direction DR1. The second bus bar BSB2 may be positioned in the direction in which the second terminal 112b protrudes, extends in the third direction DR3, and then bends in a direction opposite to the first direction DR1. Accordingly, the bent portion of each of the first bus bar BSB1 and the second bus bar BSB2 may be positioned adjacent to the opening surface 122 of the cell case 120. Accordingly, one end of the first bus bar BSB1 may be bent in the first direction DR1, electrically connecting the first terminal 112a connected to the first bus bar BSB1 in the third direction DR3 to an external component connected to the first bus bar BSB1. Similarly, one end of the second bus bar BSB2 may be bent in the opposite direction DR1 to electrically connecting the second terminal 112b connected to the second bus bar BSB2 in the third direction DR3 to an external component connected to the second bus bar BSB2.

In an embodiment, the first bus bar BSB1 and the second bus bar BSB2 may each be formed of a conductor with high electrical conductivity to electrically connect to the battery cell 110. The first bus bar BSB1 and the second bus bar BSB2 may electrically connect the battery cell 110 to an external device. For example, the first bus bar BSB1 and the second bus bar BSB2 may electrically connect the battery cell 110 to another battery cell 110.

In an embodiment, the first bus bar BSB1 and the second bus bar BSB2 may each have an opening hole HL formed through the first bus bar BSB1 and the second bus bar BSB2. This will be described in more detail below.

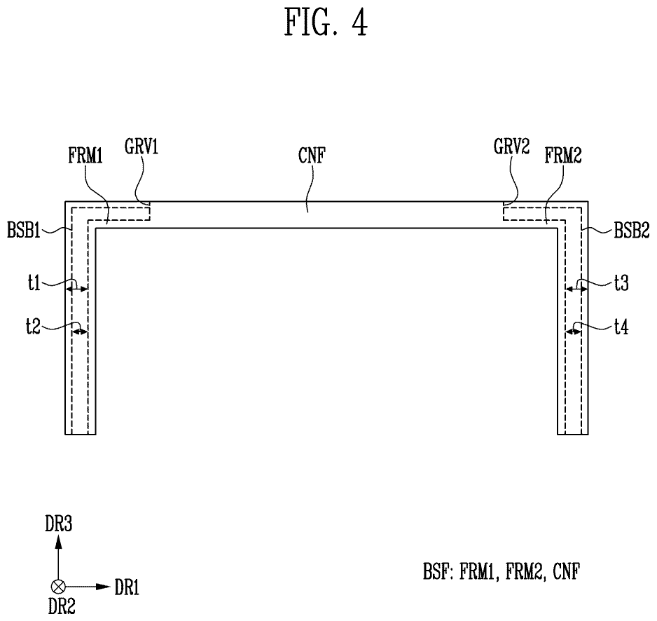

FIG. 4 is a front view of a busbar frame, a first busbar, and a second busbar of FIG. 1. For example, FIG. 4 is a front view of the busbar frame, the first busbar, and the second busbar of FIG. 1, viewed from the second direction DR2.

Referring to FIGS. 1 to 4, the busbar frame BSF may support the first busbar BSB1 and the second busbar BSB2. At least a portion of the busbar frame BSF is coupled to the first busbar BSB1 and the second busbar BSB2 and, like the battery cell 110, may be positioned within the cell case 120. The busbar frame BSF may be secured to the cell case 120 by bolts. However, the embodiments are not limited thereto.

A busbar frame BSF may include a first frame FRM1 supporting a first busbar BSB1 and a second frame FRM2 supporting a second busbar BSB2. Furthermore, the busbar frame BSF may further include a connecting frame CNF connecting the first frame FRM1 and the second frame FRM2. The busbar frame BSF may be coupled to the first busbar BSB1 and the second busbar BSB2 through thermal fusion. However, the embodiments are not limited thereto.

The first frame FRM1 is positioned in the direction in which the first terminal 112a protrudes and can be positioned between the battery cell 110 and the first bus bar BSB1. That is, the first terminal 112a may pass through the first frame FRM1 and be connected to the first bus bar BSB1.

The first frame FRM1 may include a first groove GRV1 that is at least partially recessed toward the battery cell 110. The first bus bar BSB1 may be positioned facing the first groove GRV1. For example, the first frame FRM1 may include a first groove GRV1 that is entirely recessed toward the battery cell 110. The first bus bar BSB1 may be positioned within the first groove GRV1. Accordingly, the first groove GRV1 may have a shape corresponding to that of the first bus bar BSB1. That is, the first groove GRV1, like the first bus bar BSB1, may be formed to include at least one bent portion and may be formed in an L-shape. The first groove GRV1 may be formed to extend in the third direction DR3 and then be bent in the first direction DR1. However, the embodiments are not limited thereto.

The thickness t1 of the recessed portion of the first groove GRV1 may be greater than or equal to the thickness t2 of the corresponding first busbar BSB1. This prevents the first busbar BSB1 from protruding beyond the busbar frame BSF when viewed in the second direction DR2, thereby reducing the risk of damage to the first busbar BSB1.

The second frame FRM2 may be positioned in the direction in which the second terminal 112b protrudes, and may be positioned between the battery cell 110 and the second busbar BSB2. That is, the second terminal 112b may pass through the second frame FRM2 and be connected to the second busbar BSB2.

The second frame FRM2 may include a second groove GRV2 that is at least partially recessed toward the battery cell 110. The second bus bar BSB2 may be positioned facing the second groove GRV2. For example, the second frame FRM2 may include a second groove GRV2 that is entirely recessed toward the battery cell 110. The second bus bar BSB2 may be positioned within the second groove GRV2. Therefore, the second groove GRV2 may have a shape corresponding to that of the second bus bar BSB2. That is, the second groove GRV2, like the second bus bar BSB2, may be formed to include at least one bent portion and may be formed in an L-shape. The second groove GRV2 may be formed to extend in the third direction DR3 and then be bent in a direction opposite to the first direction DR1. However, the embodiments are not limited thereto.

The thickness t3 of the recessed portion of the second groove GRV2 may be greater than or equal to the thickness t4 of the corresponding second busbar BSB2. This prevents the second busbar BSB2 from protruding beyond the busbar frame BSF when viewed in the second direction DR2, thereby reducing the risk of damage to the second busbar BSB2.

In an embodiment, the first frame FRM1, the second frame FRM2, and the connecting frame CNF may be formed integrally. For example, the busbar frame BSF may be formed by bending a single straight frame such that the first frame FRM1 and the second frame FRM2 face each other. However, embodiments are not limited thereto, and in other embodiments, the first frame FRM1, the second frame FRM2, and the connecting frame CNF may be formed separately and connected through a coupling.

In an embodiment, the busbar frame BSF may have a U-shape. Specifically, with respect to the connecting frame CNF, the first frame FRM1 may be positioned in a direction opposite to the first direction DR1 and may have a shape that is bent in a direction opposite to the third direction DR3. With respect to the connecting frame CNF, the second frame FRM2 may be positioned in the first direction DR1 and may have a shape that is bent in a direction opposite to the third direction DR3.

More specifically, the connecting frame CNF faces the support surface 121 of the cell case 120, and the battery cell 110 may be positioned between the support surface 1221 of the cell case 120). Furthermore, since the battery cell 110 is positioned between the first frame FRM1 and the second frame FRM2, the busbar frame BSF may have an angular U-shape.

Referring back to FIGS. 1 and 2, in an embodiment, the busbar frame BSF may be spaced apart from the support surface 121 of the cell case 120. The battery cell 110 is positioned on the support surface 121, but the busbar frame BSF is spaced apart from the support surface 121, thereby forming a discharge passage PTH formed by the busbar frame BSF being spaced apart from the support surface 121. The discharge passage PTH may be defined as a space having four sides, each of the support surface 121, a portion of the first surface 123, the second surface 124, and the bottom surface of the busbar frame BSF. The discharge passage PTH may be formed on opposite sides of the battery cell 110 in the first direction DR1 and in a direction opposite to the first direction DR1 with respect to the battery cell 110. This may be utilized as a gas discharge path in the event of a fire in the battery cell 110.

The battery cell assembly 100 may further include a fixing member TP. The fixing member TP is positioned on the connecting frame CNF to secure the first side 123 and the second side 124 of the cell case 120. That is, the fixing member TP may be positioned facing the support surface 121. Therefore, the fixing member TP, the support surface 121 of the cell case 120, and the heat-dissipating adhesive ADH prevent the battery cell 110 from moving in the third direction DR3. Additionally, since the fixing member TP is arranged on the busbar frame BSF and attached to the first surface 123 and the second surface 124, movement between the cell case 120 and the busbar frame BSF may also be prevented.

The battery cell assembly 100 may further include a first insulating cover ISC1 and a second insulating cover ISC2. The first insulating cover ISC1 may be positioned on the outside of the first busbar BSB1 and may cover the first busbar BSB1. The second insulating cover ISC2 may be positioned on the outside of the second busbar BSB2 and may cover the second busbar BSB2. The first insulating cover ISC1 may prevent current flow between the first busbar BSB1 and the cell case 120, and the second insulating cover ISC2 may prevent current flow between the second busbar BSB2 and the cell case 120. Since the first busbar BSB1 may be connected to other components through the opening hole HL, the first insulating cover ISC1 may cover the first busbar BSB1 except for the portion of the opening hole HL defined in the first busbar BSB1. Since the second busbar BSB2 may be connected to other components through the opening hole HL defined in the second busbar BSB2, the second insulating cover ISC2 may cover the second busbar BSB2 except for the portion of the opening hole HL in the second busbar BSB2.

Additionally, the first insulating cover ISC1 and the second insulating cover ISC2 may be spaced apart from the support surface 121 of the cell case 120 to form a discharge passage PTH. Accordingly, gas emitted from the battery cell 110 may be discharged through the lower portion of each of the first insulating cover ISC1 and the second insulating cover ISC2.

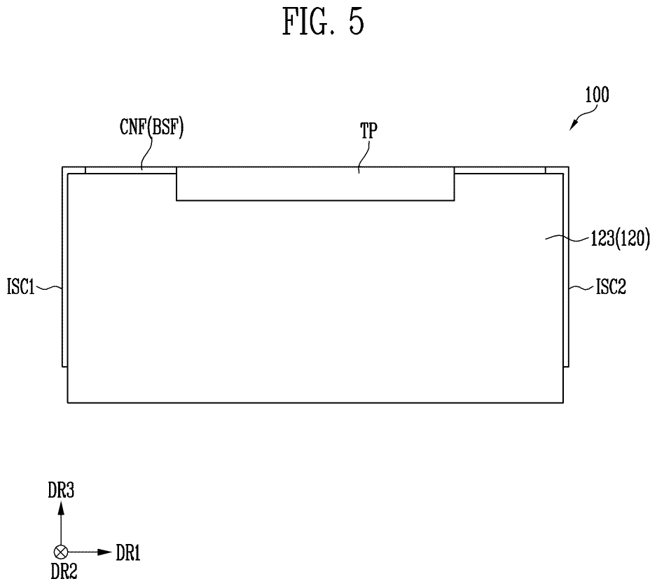

FIG. 5 is a front view of a battery cell assembly according to an embodiment of the present disclosure. For example, FIG. 5 is a front view of the battery cell assembly of FIG. 1, viewed from a second direction DR2.

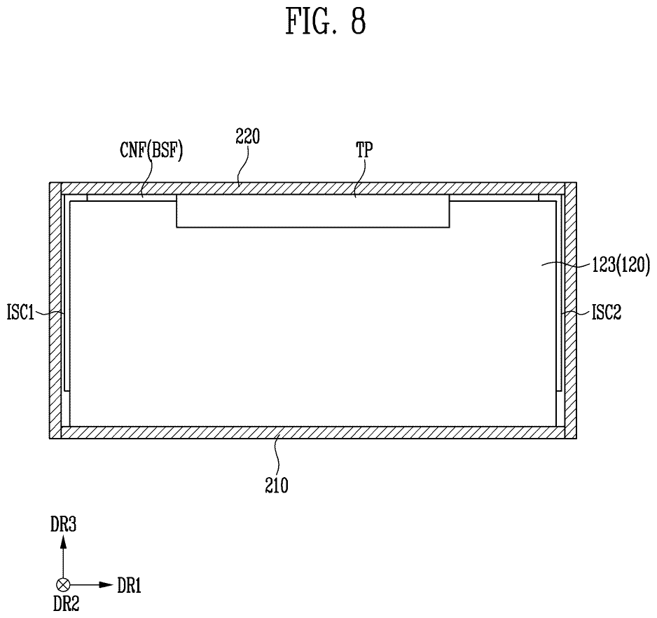

In a battery cell assembly 100 according to an embodiment of the present disclosure, at least a portion of the connecting frame CNF of the busbar frame BSF may protrude from the opening surface 122. That is, when viewed from the second direction DR2, a portion of the busbar frame BSF may protrude in a third direction DR3 relative to the first surface 123 and the second surface 124 of the cell case 120. Accordingly, the busbar frame BSF, rather than the cell case 120, may support the pack cover 220 of the housing 200 that houses the battery cell assembly 100 (see FIG. 8).

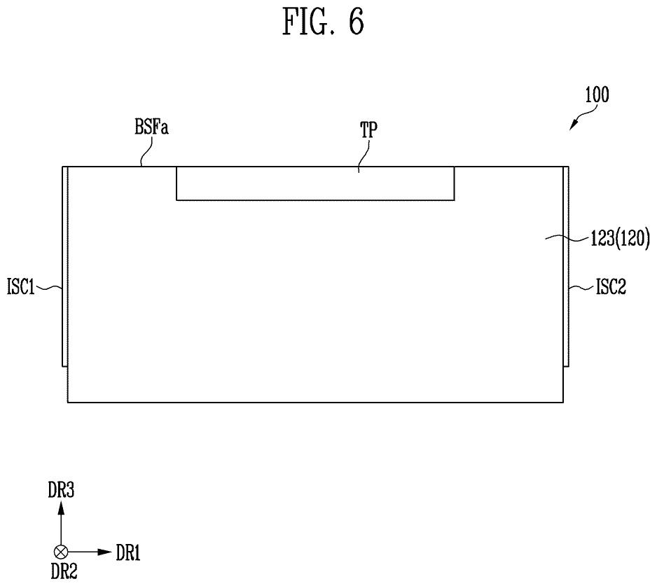

FIG. 6 is a front view of a battery cell assembly according to another embodiment of the present disclosure. For example, FIG. 6 is a front view of the battery cell assembly of FIG. 1, viewed from the second direction DR2.

In another embodiment of the present disclosure, in a battery cell assembly 101, the upper surface BSFa of the busbar frame BSF in the third direction DR3 may be coplanar with the first surface 123 and the second surface 124 of the cell case 120. That is, when viewed from the second direction DR2, the busbar frame BSF may not protrude from the opening surface 122. Accordingly, both the cell case 120 and the busbar frame BSF may support the pack cover 220 of the housing 200 that houses the battery cell assembly 100. However, embodiments according to the present disclosure are not limited thereto, and the busbar frame BSF may be positioned inward in a direction opposite to the third direction DR3 from the opening surface 122 of the cell case 120.

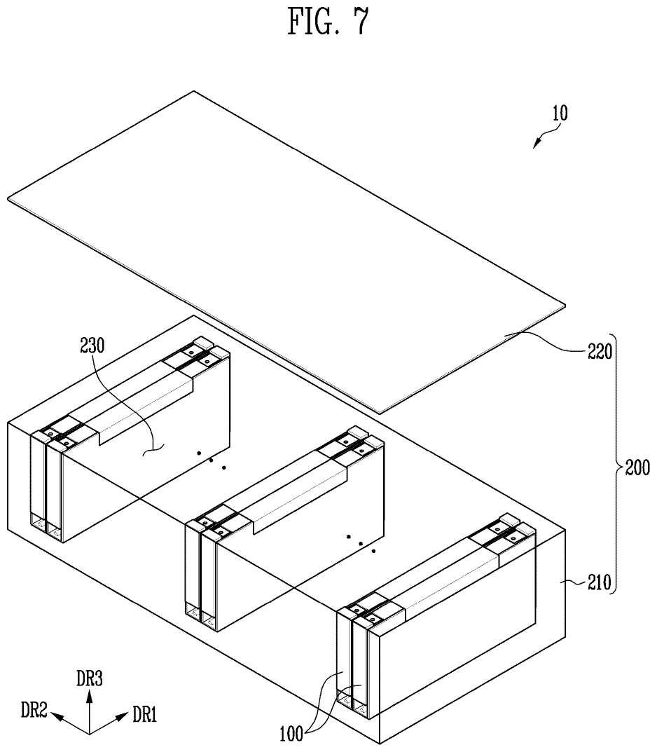

FIG. 7 is a perspective view of a battery system according to an embodiment of the present disclosure.

Referring to FIG. 7, a battery system 10 may include a plurality of battery cell assemblies 100, a connecting bus bar CNB electrically connecting the plurality of battery cell assemblies 100, and a housing 200 that accommodates the plurality of battery cell assemblies 100 and the connecting bus bar CNB. For example, the battery system 10 may include a plurality of battery cell assemblies 100 of FIG. 1.

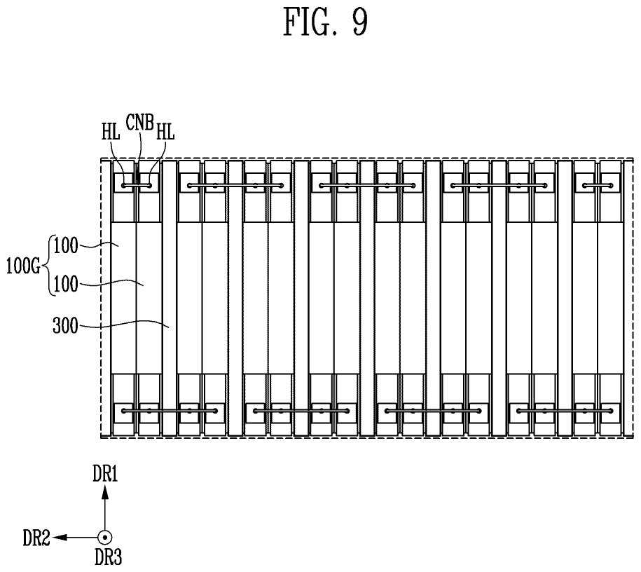

The connecting bus bar CNB may electrically connect the plurality of battery cell assemblies 100. The connecting bus bar CNB may connect at least one battery cell assembly 100 to each other. The connecting bus bar CNB may be provided in a plurality of numbers, and a battery group 100G including battery cell assemblies 100 connected by the connecting bus bar CNB may be formed in a plurality of numbers (see FIG. 9).

The housing 200 may receive a plurality of battery cell assemblies 100 and connecting bus bars CNBs. The housing 200 includes an opening 230 on one surface, a pack body 210 that forms a space for receiving a plurality of battery cell assemblies 100 and connecting bus bars CNBs through the opening 230, and a pack cover 220 that couples to the pack body 210 to form the space together and covers the opening 230.

A plurality of battery cell assemblies 100 and connecting bus bars CNBs may be arranged within the space of the pack body 210, and the pack cover 220 may cover the plurality of battery cell assemblies 100 and connecting bus bars CNBs from above. The plurality of battery cell assemblies 100 may be stacked along a preset stacking direction. While FIG. 7 illustrates an example in which a plurality of battery cell assemblies 100 are stacked in the second direction DR2, the plurality of battery cell assemblies 100 may also be stacked in other directions.

FIG. 7 illustrates an example in which a predetermined number of a plurality of battery cell assemblies 100 are arranged in a single column along the second direction DR2. However, this is merely an example, and the arrangement and number of the plurality of battery cell assemblies 100 may be varied in any way, and the number of rows and columns may also vary accordingly.

FIG. 8 is a cross-sectional view of a battery system as viewed from the stacking direction of a battery cell assembly.

Referring to FIG. 8, a plurality of battery cell assemblies 100 may support a pack cover 220. In an embodiment, if the connecting frame CNF of each battery cell assembly 100 protrudes beyond the cell case 120, the connecting frame CNF may support the pack cover 220 (see FIG. 5). That is, the busbar frame BSF, rather than the cell case 120, may support the pack cover 220. In another embodiment, the upper surface BSFa of the busbar frame BSF in the third direction DR3 of each battery cell assembly 100 may be coplanar with the first surface 123 and the second surface 124 of the cell case 120 (see FIG. 6). That is, the cell case 120 and the busbar frame BSF may simultaneously support the pack cover 220. In another embodiment, in each battery cell assembly 100, the busbar frame BSF may be positioned inwardly relative to the opening 122 of the cell case 120, in a direction opposite to the third direction DR3. That is, in this case, the cell case 120, rather than the busbar frame BSF, may support the pack cover 220.

FIG. 9 is a plan view of a portion of a battery system of FIG. 7.

Referring to FIGS. 7 and 9, a battery group 100G may be formed by grouping a plurality of battery cell assemblies 100 in a preset number. The battery cell assemblies 100 within the battery group 100G may be electrically connected to each other. The battery cell assemblies 100 within the battery group 100G may be electrically connected to each other by a connecting bus bar CNB connected to the first bus bar BSB1 or the second bus bar BSB2. Although FIG. 9 illustrates an example in which two battery cell assemblies 100 form one battery group 100G, the number of battery cell assemblies 100 forming the battery group 100G and the number of battery groups 100G may be varied.

Specifically, the first bus bar BSB1 and the second bus bar BSB2 may each include the opening hole HL penetrating in a direction from the pack cover 220 toward the pack body 210. A connecting bus bar CNB may be electrically connected to at least one of the first bus bar BSB1 or the second bus bar BSB2 through the opening hole HL. Thus, battery cell assemblies 100 within a battery group 100G may be electrically connected to each other via the connecting bus bar CNB. Additionally, adjacent battery groups 100G within a battery system 10 may also be electrically connected to each other via the connecting bus bar CNB.

Battery cell assemblies 100 within a battery group 100G may be connected in parallel, with their poles connected to each other. This may increase the capacity of the battery cells 110. Adjacent battery groups 100G within the battery system 10 may be connected in series with their polarities connected to each other. This may increase the voltage of the battery cells 110. The capacity and voltage of the battery system 10 may be adjusted by varying the number of battery cell assemblies 100 within the battery group 100G and the number of battery groups 100G.

The battery system 10 may further include at least one cell pad 300 disposed between the plurality of battery cell assemblies 100. The cell pad 300 may be disposed within the receiving space of the pack body 210 and between the plurality of battery groups 100G. The cell pad 300 may be arranged alternately with the battery groups 100G in the second direction DR2. The cell pad 300 may cushion external impacts between battery groups 100G and block or disperse heat between the battery groups 100G.

In an embodiment, by housing the battery cells 110 in the cell case 120 to ensure the structural stability of the battery cell assembly 100, the battery system 10 may be formed without forming a battery module including the battery cells 110. This eliminates the need for separate components or manufacturing processes for forming the battery module, thereby reducing the number of parts and improving manufacturing efficiency. Furthermore, by forming the battery system 10 with the battery cell assembly 100 without forming a battery module requiring a separate housing, space utilization may be improved. Furthermore, since the battery cell assembly 100 has exhaust passages PTH formed on both sides of the battery cells 110 to allow gas discharge, gas may be easily discharged in the event of a fire in the battery cell assembly 100. Accordingly, the reliability of the battery cell assembly 100 and battery system 10 may be improved.

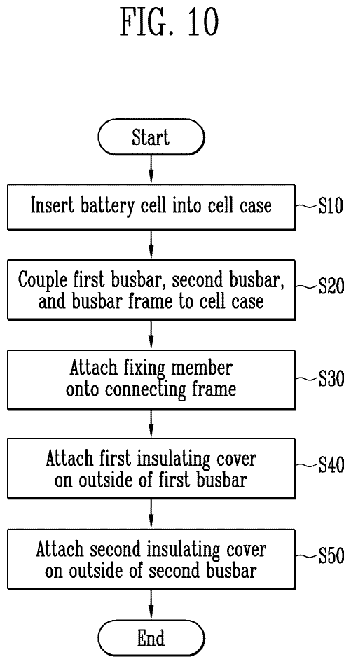

FIG. 10 is a flowchart illustrating a method of manufacturing a battery cell assembly according to an embodiment of the present disclosure.

Referring to FIG. 10, a method of manufacturing a battery cell assembly 100 according to the present disclosure may include S10 inserting a battery cell 110 into a cell case 120 and S20 coupling a first bus bar BSB1, a second bus bar BSB2, and a bus bar frame BSF to the cell case 120.

After manufacturing a cell case 120 including a support surface 121, an opening surface 122 facing the support surface 121, and a first surface 123 and a second surface 124 extending toward the opening surface 122 so as to face each other on opposite sides of the support surface 121, a battery cell 110 may be inserted into the cell case 120. After applying a heat-dissipating adhesive ADH to the support surface 121 of the cell case 120, the support surface 121 and the battery cell 110 may be coupled via the heat-dissipating adhesive ADH.

A busbar frame BSF may be coupled to the cell case 120, including a first busbar BSB1 electrically connected to a first terminal 112a, a second busbar BSB2 electrically connected to a second terminal 112b, a first frame FRM1 and a second frame FRM2 that support the first busbar BSB1 and the second busbar BSB2, respectively, and a connecting frame CNF that protrudes at least a portion of the frame from the opening 122 and connects the first frame FRM1 and the second frame FRM2. In an embodiment, a busbar frame BSF may be coupled to a first busbar BSB1 and a second busbar BSB2 through thermal fusion, and with the first busbar BSB1 and the second busbar BSB2 coupled to the busbar frame BSF, the first busbar BSB1, the second busbar BSB2, and the busbar frame BSF may be coupled to the cell case 120.

When the first busbar BSB1, the second busbar BSB2, and the busbar frame BSF are coupled to the cell case 120, the first busbar BSB1 and the first frame FRM1 may be coupled to the first terminal 112a, and the second busbar BSB2 and the second frame FRM2 may be coupled to the second terminal 112b. The first terminal 112a and the first bus bar BSB1 may be welded and coupled together, and the second terminal 112b and the second bus bar BSB2 may be welded and coupled together.

The method for manufacturing a battery cell assembly 100 according to the present disclosure may include S30 attaching a fixing member TP to a connecting frame CNF, S40 attaching a first insulating cover ISC1 to the outside of the first bus bar BSB1, and S50 attaching a second insulating cover ISC2 to the outside of the second bus bar BSB2. FIG. 10 illustrates an example in which attaching a fixing member TP on a connecting frame CNF S30, attaching a first insulating cover ISC1 to the outside of a first bus bar BSB1 S40, and attaching a second insulating cover ISC2 to the outside of a second bus bar BSB2 S50 are performed sequentially. However, attaching a fixing member TP on a connecting frame CNF S30, attaching a first insulating cover ISC1 to the outside of a first bus bar BSB1 S40, and attaching a second insulating cover ISC2 to the outside of a second bus bar BSB2 S50 may be performed in parallel. In addition, the order of S30 attaching a fixing member TP on a connecting frame CNF, S40 attaching a first insulating cover ISC1 to the outside of a first bus bar BSB1, and S50 of attaching a second insulating cover ISC2 to the outside of a second bus bar BSB2 may also be changed.

A fixing member TP connecting the first side 123 and the second side 124 of the cell case 120 may be attached to the connecting frame CNF. By placing the fixing member TP on the connecting frame CNF and connecting the first side 123 and the second side 124, movement between the bus bar frame BSF and the cell case 120 may be prevented.

A first insulating cover ISC1 may be attached to the outside of the first bus bar BSB1. A second insulating cover ISC2 may be attached to the outside of the second bus bar BSB2. The first insulating cover ISC1 may prevent current flow between the first busbar BSB1 and the cell case 120, and the second insulating cover ISC2 may prevent current flow between the second busbar BSB2 and the cell case 120.

Accordingly, a battery cell assembly 100 may be formed, including a cell case 120, a heat-dissipating adhesive ADH, a battery cell 110, a busbar frame BSF, a first busbar BSB1, a second busbar BSB2, a first insulating cover ISC1, a second insulating cover ISC2, and a fixing member TP.

The present disclosure may be implemented in various modified forms, and the scope of the present disclosure is not limited to the above-described embodiments. Therefore, if a modified embodiment includes elements of the claims of the present disclosure, it should be considered to fall within the scope of the present disclosure.

What is claimed is:

1. A battery cell assembly, comprising:
a battery cell including an exterior material housing an electrode assembly therein, and a first terminal and a second terminal electrically connected to the electrode assembly and protruding outward from the exterior material;
a cell case including a support surface facing one side of the battery cell, an opening surface facing the support surface, and first and second surfaces extending perpendicular to the support surface from opposite ends of the support surface toward the opening surface;
a first bus bar electrically connected to the first terminal;
a second bus bar electrically connected to the second terminal; and
a bus bar frame including a first frame and a second frame each supporting the first bus bar and the second bus bar, and a connecting frame of which at least a portion protrudes from the opening surface and which includes the first frame and the second frame.

2. The battery cell assembly of claim 1, wherein the first frame, the second frame, and the connecting frame are formed integrally.

3. The battery cell assembly of claim 1, wherein the busbar frame has a U-shape.

4. The battery cell assembly of claim 1, wherein the first frame comprises a first groove that is at least partially sunken in a direction toward the battery cell, and
wherein the second frame comprises a second groove that is at least partially sunken in a direction toward the battery cell.

5. The battery cell assembly of claim 4, wherein the first bus bar is arranged facing the first groove, and
wherein the second bus bar is arranged facing the second groove.

6. The battery cell assembly of claim 4, wherein the thickness of the sunken portion of the first groove is greater than or equal to the thickness of the corresponding first bus bar, and
wherein the thickness of the sunken portion of the second groove is greater than or equal to the thickness of the corresponding second bus bar.

7. The battery cell assembly of claim 4, wherein each of the first busbar and the second busbar comprises at least one bent portion.

8. The battery cell assembly of claim 7, wherein each of the first bus bar and the second bus bar has an L-shape.

9. The battery cell assembly of claim 1, further comprising
a fixing member arranged on the connecting frame and fixing the connecting frame and the first surface and the second surface of the cell case.

10. The battery cell assembly of claim 1, further comprising:
a first insulating cover arranged on the outside of the first busbar; and
a second insulating cover arranged on the outside of the second busbar.

11. The battery cell assembly of claim 1, wherein the busbar frame is spaced apart from the support surface of the cell case.

12. The battery cell assembly of claim 1, wherein the first bus bar is coupled to the first terminal by bonding, and
wherein the second bus bar is coupled to the second terminal by bonding.

13. A battery system, comprising:
a plurality of battery cell assembly;
a connecting busbar electrically that connects the plurality of battery cell assemblies; and
a housing that houses the plurality of battery cell assemblies and the connecting busbar, wherein the battery cell assembly comprises:
a battery cell including an exterior material housing an electrode assembly therein, and a first terminal and a second terminal electrically connected to the electrode assembly and protruding outward from the exterior material;
a cell case including a support surface facing one side of the battery cell, an opening surface facing the support surface, and first and second surfaces extending perpendicular to the support surface from opposite ends of the support surface toward the opening surface;
a first bus bar electrically connected to the first terminal;
a second bus bar electrically connected to the second terminal; and
a bus bar frame including a first frame and a second frame each supporting the first bus bar and the second bus bar, and a connecting frame of which at least a portion protrudes from the opening surface and which includes the first frame and the second frame.

14. The battery system of claim 13, further comprising
at least one cell pad arranged between the plurality of battery cell assemblies.

15. The battery system of claim 14, wherein the housing comprises:
a pack body having an opening on one surface and forming a receiving space that houses the plurality of battery cell assemblies and the connecting busbar through the opening; and
a pack cover coupled to the pack body to form the receiving space together and covering the opening.

16. The battery system of claim 15, wherein the first bus bar and the second bus bar each include an opening hole penetrating in a direction from the pack cover toward the pack body.

17. The battery system of claim 16, wherein the connecting bus bar is electrically connected to at least one of the first bus bar or the second bus bar through the opening hole.

18. The battery system of claim 15, wherein the connecting frame supports the pack cover.

19. A method of manufacturing a battery cell assembly comprising an exterior material that houses an electrode assembly therein and a battery cell including a first terminal and a second terminal electrically connected to the electrode assembly and protruding outward from the exterior material, and a cell case that houses the battery cell, the method comprising:
inserting the battery cell into the cell case, the cell case including a support surface, an opening facing the support surface, and first and second surfaces extending perpendicular to the support surface and toward the opening from opposite ends of the support surface; and
coupling a busbar frame to the cell case, the busbar frame including a first busbar electrically connected to the first terminal, a second busbar electrically connected to the second terminal, a first frame and a second frame that respectively support the first and second busbars, and a connecting frame of which at least a portion protrudes from the opening surface to connect the first and second frames.

20. The method of claim 19, further comprising
attaching a fixing member that connects the first surface and the second surface of the cell case to the connecting frame.
